(19) United States
(12) Patent Application Publication
(10) Pub. No.: US 2008/0000578 A1
(43) Pub. Date: Jan. 3, 2008

(54) METHOD OF PRODUCING BREAST CUP HAVING A PATTERN

(76) Inventor: Shao-Tsung Wang, Tainan (TW)

Correspondence Address: DARBY & DARBY P.C., P.O. BOX 770, Church Street Station, New York, NY, 10008-0770, US

(21) Appl. No.: 11/427,999

(22) Filed: Jun. 30, 2006

(51) Int. Cl. B44C 1/165; B29C 70/34

(52) U.S. Cl. 156/230; 264/257; 264/293; 264/321; 264/324

(57) ABSTRACT

A method of producing a breast cup having a pattern includes the steps of: (a) preparing a substrate having inner and outer fabric layers that sandwich a foam layer; (b) placing a patterning plate over a surface of the substrate; and (c) forming the substrate into a cup and simultaneously providing the surface of the substrate with a pattern corresponding to the patterning plate by hot-pressing the substrate in the presence of the patterning plate.

### BACKGROUND OF THE INVENTION

1. Field of the Invention

The invention relates to a manufacturing method, more particularly to a method of producing a breast cup having a pattern on an outer surface thereof.

2. Description of the Related Art

A conventional method of producing a breast cup includes the steps of: preparing a foam layer and two fabric layers; adhering the fabric layers respectively on inner and outer faces of the foam layer; and hot-pressing the assembly of fabric and foam layers in a male-female mold so as to form a breast cup. To enhance the appearance of the breast cup, the female mold is engraved with a predetermined pattern so that after the hot-pressing process, an outer surface of the breast cup is provided with the pattern.

Although the aforementioned conventional method can produce a breast cup having a pattern on the outer surface thereof, the cost of the mold is increased because the mold is engraved directly with a predetermined pattern and can produce only one pattern. If an alternative pattern is desired, another mold must be made, which is quite expensive. Hence, the conventional method is suitable only for production of a large number of identically patterned breast cups.

### SUMMARY OF THE INVENTION

Therefore, the object of the present invention is to provide a method of producing a breast cup that can permit easy changing of patterns on an outer surface of the breast cup to thereby minimize production costs, and permit production of the breast cups in small batches, each with a different pattern.

According to this invention, a method of producing a breast cup having a pattern comprises the steps of: (a) preparing a substrate having inner and outer fabric layers that sandwich a foam layer; (b) placing a patterning plate over a surface of the substrate; and (c) forming the substrate into a cup and simultaneously providing the surface of the substrate with a pattern corresponding to the patterning plate by hot-pressing the substrate in the presence of the patterning plate.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a breast cup made in accordance with the first preferred embodiment of a method of the present invention, in which a portion of the breast cup is removed to facilitate description of the breast cup;

FIG. 2 is an exploded perspective view used for describing production of the breast cup in accordance with the first preferred embodiment of the method of the present invention;

FIG. 3 is a fragmentary sectional view, illustrating top and bottom molds pressing against a substrate in the presence of a patterning plate in accordance with the first preferred embodiment of the method of the present invention;

FIG. 4 is an exploded perspective view used for describing production of the breast cup in accordance with the second preferred embodiment of the method of the present invention;

FIG. 5 is a schematic view of a breast cup made in accordance with the third preferred embodiment of the method of the present invention;

FIG. 6 is an exploded perspective view used for describing production of the breast cup in accordance with the fourth preferred embodiment of the method of the present invention;

FIG. 7 is a schematic view of a breast cup made in accordance with the fourth preferred embodiment;

FIG. 8 is a schematic view of a breast cup made in accordance with the fifth preferred embodiment of the method of the present invention; and

FIG. 9 is an exploded perspective view of a breast cup made in accordance with the sixth preferred embodiment of the method of the present invention.

### DETAILED DESCRIPTION OF THE PREFERRED EMBODIMENTS

Before the present invention is described in greater detail, it should be noted that like elements are denoted by the same reference numerals throughout the disclosure.

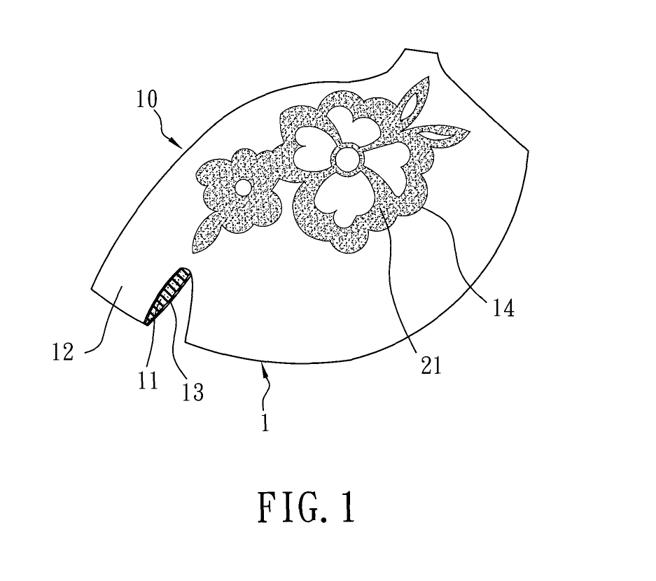

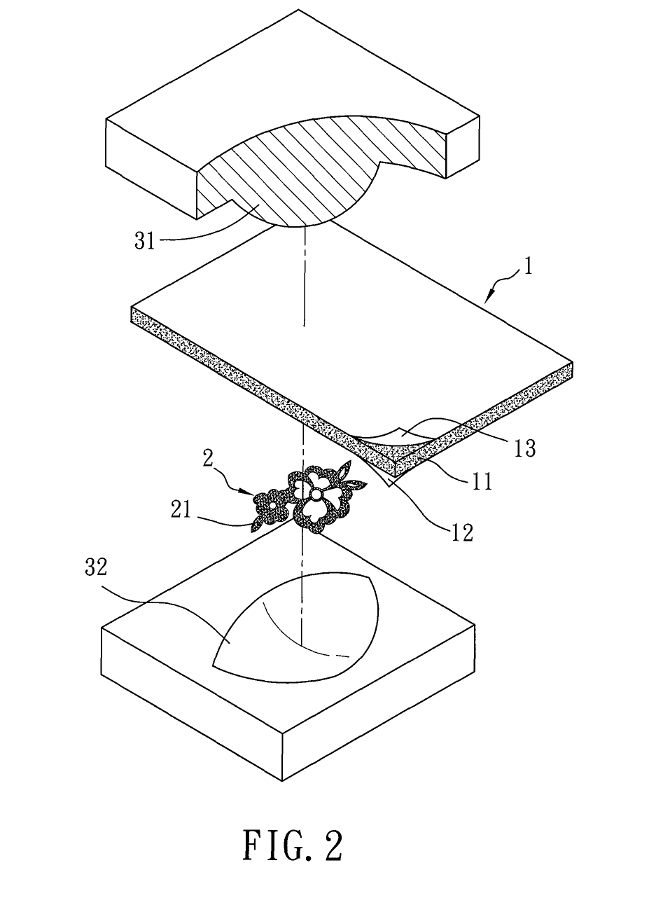

FIG. 1 illustrates a breast cup 10 made in accordance with the first preferred embodiment of a method of the present invention. As shown, the breast cup 10 has a pattern 14 provided on an outer surface thereof. The breast cup 10 is made from a substrate 1. The substrate 1, as shown also in FIG. 2, includes a foam layer 11 made of rubber or plastic foam, an outer fabric layer 12 connected to an outer face of the foam layer 11, and an inner fabric layer 13 connected to an inner face of the foam layer 11. The inner and outer fabric layers 13, 12 can be made of woven or nonwoven fabric materials. The pattern 14 is formed on the outer fabric layer 12, and may include a figure, a geometric line(s), or lettering.

The substrate 1, in an alternative embodiment, may include only two layers: the foam layer 11, and one of the inner or outer fabric layer 13, 12. When the outer fabric layer 12 is not included in the structure of the substrate 1, the pattern 14 is formed directly on the outer face of the foam layer 11.

In the manufacturing process, a flexible, temperature-resistant patterning plate 2 is used to form the pattern 14 on the outer surface of the breast cup 10. The patterning plate 2 is formed with a predetermined profile. In this embodiment, the profile of the patterning plate 2 resembles a figure of a flower. The patterning plate 2 is made by cutting a paper sheet having a thickness of 0.5 to 1 mm to a desired profile, and is provided with a coating layer 21. As an example, the coating layer 21 may be a transfer-printing ink. The patterning plate 2, in an alternative embodiment, may be made of a thin metal sheet. In another alternative embodiment, the patterning plate 2 may not be provided with the coating layer 21.

According to the first preferred embodiment of the present invention, a method for producing the breast cup 10 shown in FIG. 1 is carried out as follows:

The substrate 1 is prepared. The substrate 1 includes the inner and outer fabric layers 13, 12 that sandwich the foam layer 11. The patterning plate 2 having the coating layer 21 is also prepared.

The patterning plate 2 is first placed in a depression of a female mold 32 with the coating layer 21 facing upwardly, after which the substrate 1 is placed over the patterning plate 2 with the outer fabric layer 12 facing the patterning plate 2. Subsequently, the female mold 32 is covered with a male mold 31 which has a projection. In order to prevent displacement of the patterning plate 2 in the female mold 32, the patterning plate 2 may be adhered to the female mold 32 through a heat-resistant adhesive agent, such as silicone, so as to fix the position of the patterning plate 2 in the depression of the female mold 32.

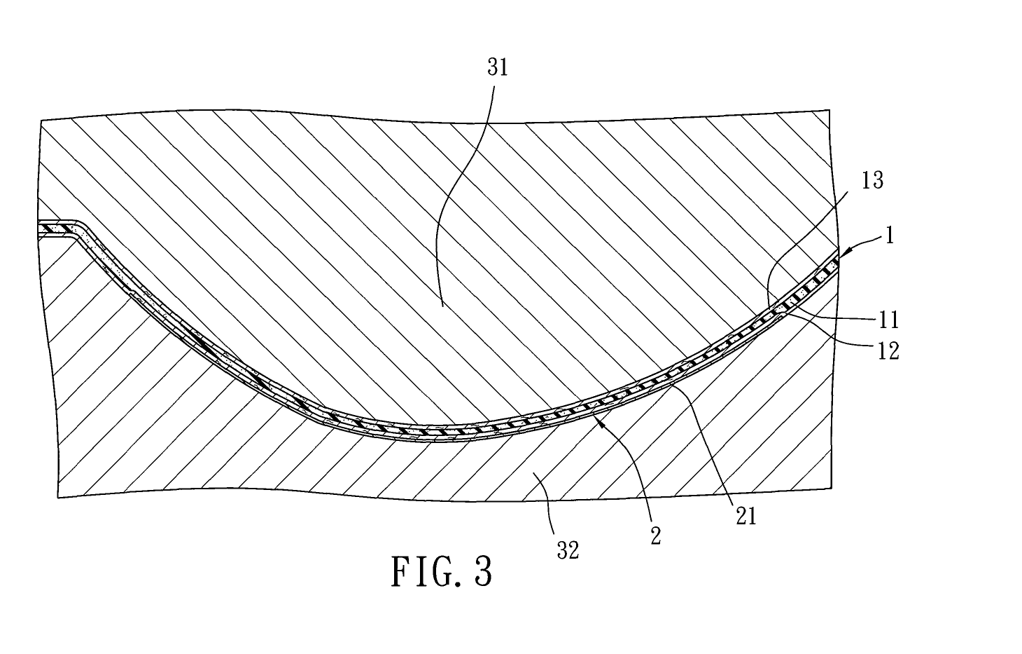

By pressing the male mold 31 onto the female mold 32, as shown in FIG. 3, the substrate 1 is formed into the breast cup 10, and simultaneously, the outer fabric layer 12 is provided with the pattern 14 corresponding to the patterning plate 2. A hot-pressing process is used at this time, such that the coating layer 21 is transfer-printed onto the outer fabric layer 12 of the substrate 1.

The male mold 31 is subsequently lifted away from the female mold 32 to allow for removal of the breast cup 10. The breast cup 10 is therefore formed with the pattern 14 corresponding to the profile of the patterning plate 2.

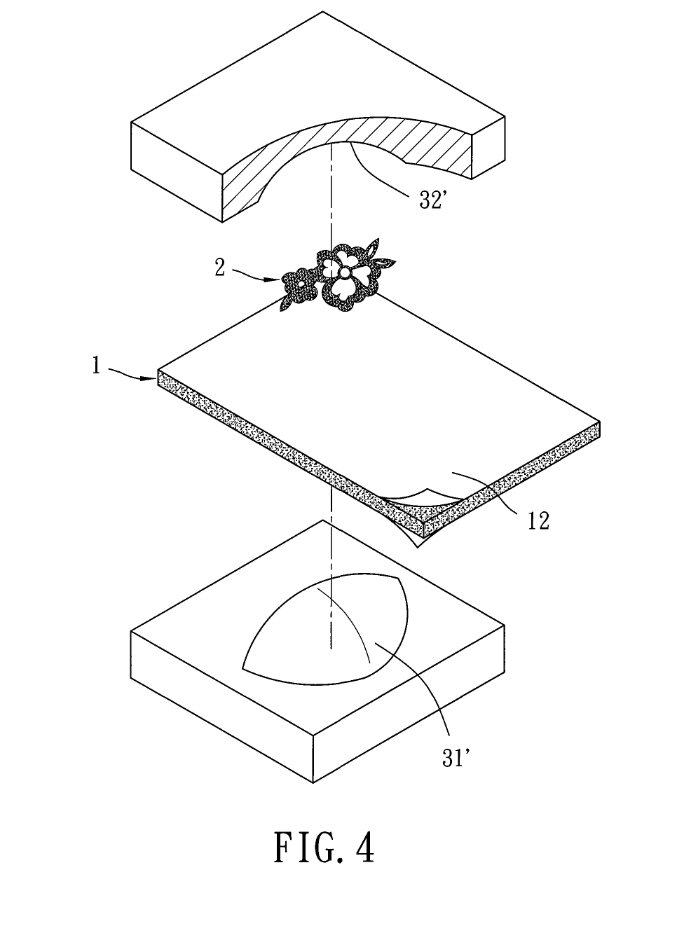

Referring to FIG. 4, according to the second preferred embodiment of the present invention, the patterning plate 2 is first placed over the outer fabric layer 12 of the substrate 1. Next, the substrate 1 together with the patterning plate 2 is placed between the female and male molds 32′, 31′, and is hot-pressed so as to obtain a similar result as that of the first preferred embodiment.

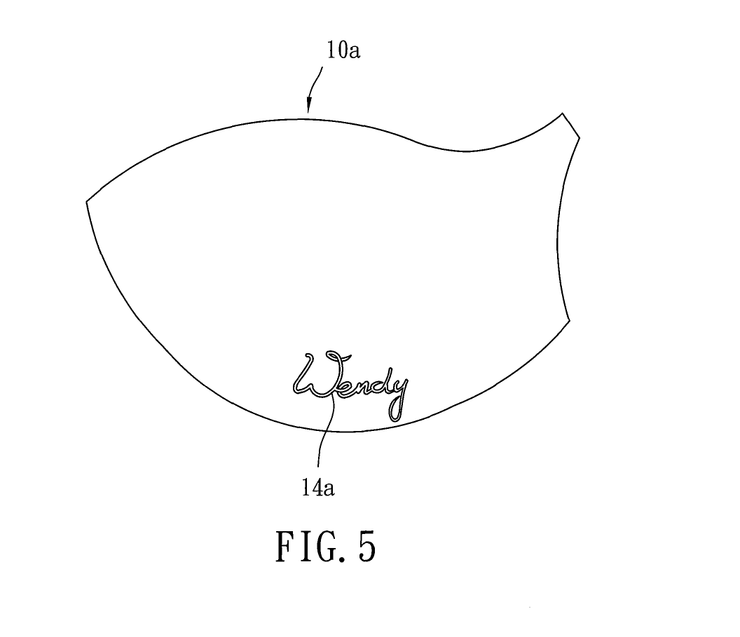

Referring to FIG. 5, according to the third preferred embodiment of the present invention, the patterning plate 2 in the first preferred embodiment is replaced with another patterning plate so that the breast cup (10a) is provided with a pattern (14a) that includes lettering. The lettering can spell out a person's name or a company logo, or may be in the form of a Chinese character(s), etc.

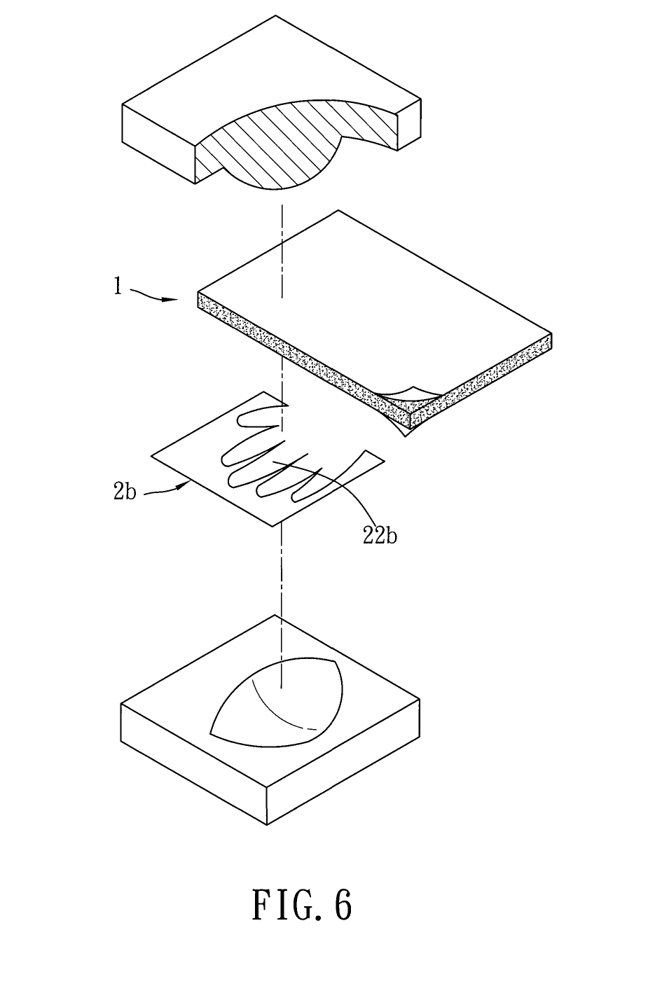

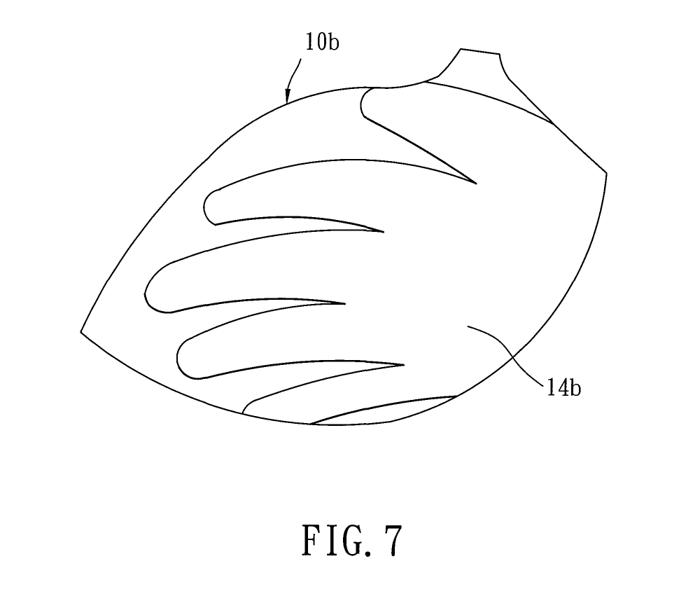

Referring to FIGS. 6 and 7, according to the fourth preferred embodiment of the present invention, a patterning plate (2b) is used in place of the patterning plate 2 used in the first preferred embodiment. The patterning plate (2b) has a profile (22b) resembling a hand. The pattern (14b) is printed on the outer surface of the breast cup (10b) as in the first preferred embodiment.

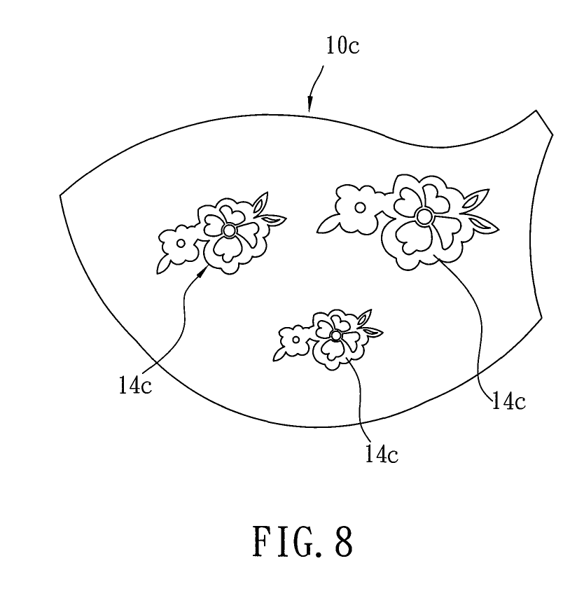

FIG. 8 illustrates a breast cup made in accordance with the fifth preferred embodiment of the present invention. In this embodiment, a plurality of patterning plates 2 (see FIG. 2) are used in place of the single patterning plate 2 used in the first preferred embodiment. The patterning plates 2 may be placed randomly, so that an irregular form of the patterns (14c) may be produced to provide a unique and enhance appearance of the breast cup (10c).

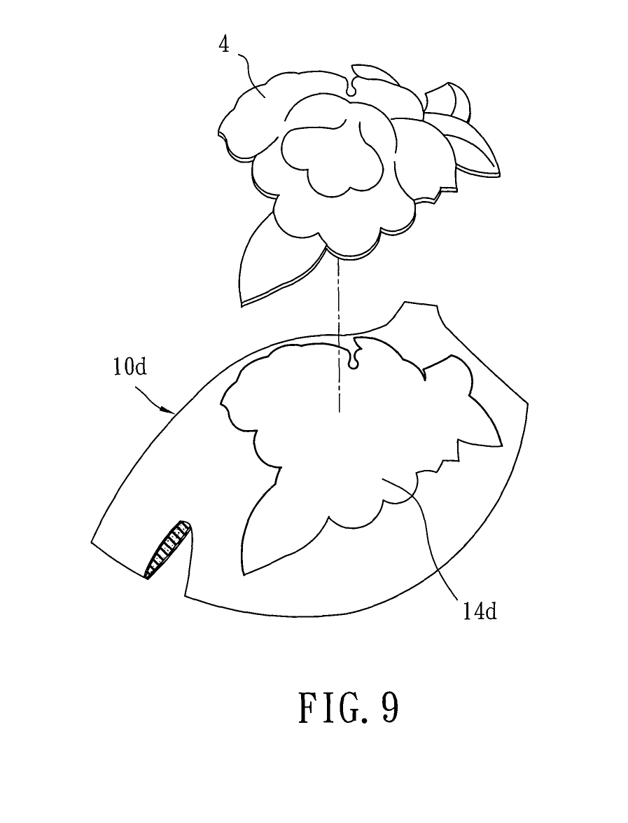

Referring to FIG. 9, according to the sixth preferred embodiment of the present invention, the method further includes the step of covering the pattern (14d) formed on the outer surface of the breast cup (10d) with a decorative piece 4. The decorative piece 4 corresponds in shape to the pattern (14d), and may be adhered or sewn to the pattern (14d) to enhance the appearance of the breast cup (10d). The decorative piece 4 may be a jacquard-woven or machine-embroidered fabric piece.

The shape, size, quantity, and position of the patterning plate 2 are not limited to the aforementioned exemplary embodiments. The patterning plate 2 may be a solid or hollow body so as to produce a raised or indented surface design on the substrate 1, and may use different thicknesses so as to vary the height or depth of the surface design.

Due to the use of the patterning plate (2, 2b), the breast cup (10, 10a, 10b, 10c, 10d) can be manufactured easily and at a low cost. Further, the need to provide engraving in the molds 31, 31′, 32, 32′ can be eliminated. Since the patterning plate (2, 2b) can be made of paper, which is easily profiled, a variety of patterning plates (2, 2b) can be produced to be selectively used with one set of the molds 31, 31′, 32, 32′, thereby reducing the cost of making the molds 31, 31′, 32, 32′. Finally, use of the patterning plate (2, 2b) in place of engraving the molds 31, 31′, 32, 32′ allows for the cost-effective production of the breast cup (10, 10a, 10b, 10c, 10d) of a particular design in small batches.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method of producing a breast cup having a pattern, comprising:
(a) preparing a substrate having inner and outer fabric layers that sandwich a foam layer;
(b) placing a patterning plate over a surface of the substrate; and
(c) forming the substrate into a cup and simultaneously providing the surface of the substrate with a pattern corresponding to the patterning plate by hot-pressing the substrate in the presence of the patterning plate.

2. The method of claim 1, wherein step (c) comprises providing a coating layer to the patterning plate and transfer-printing the coating layer onto the surface of the substrate.

3. The method of claim 1, further comprising the step of covering the pattern formed on the surface of the substrate with a decorative piece, the decorative piece corresponding in shape and position to the pattern.

4. The method of claim 1, wherein the patterning plate is made of paper.

5. The method of claim 1, wherein the patterning plate is made of metal.

6. The method of claim 1, wherein the patterning plate has a predetermined profile.

7. The method of claim 6, wherein the predetermined profile resembles a figure.
